(19) United States
(12) Patent Application Publication
(10) Pub. No.: US 2006/0119545 A1
(43) Pub. Date: Jun. 8, 2006

(54) Plasma display panel and driving method thereof

(75) Inventors: Seung-Rok Shin, Yongin-si (KR); Min Hur, Yongin-si (KR); Young-Do Choi, Yongin-si (KR)

Correspondence Address: H.C. PARK & ASSOCIATES, PLC, 8500 LEESBURG PIKE, SUITE 7500, VIENNA, VA, 22182, US

(73) Assignee: SAMSUNG SDI CO., LTD.

(21) Appl. No.: 11/294,378

(22) Filed: Dec. 6, 2005

(30) Foreign Application Priority Data
Dec. 7, 2004 (KR) 10-2004-0102240

(51) Int. Cl. G09G 3/28

(52) U.S. Cl. 345/67

(57) ABSTRACT

A method and apparatus for driving a plasma display panel (PDP) with discharge cells arranged between a first substrate and second substrate, address electrodes arranged along a first direction, first electrodes and second electrodes arranged along a second direction crossing the first direction on opposite sides of each of a discharge cell, and scan electrodes arranged along the second direction that partition each discharge cell into two discharge spaces. The two discharge spaces of one discharge cell share a scan electrode. By selectively biasing the first electrodes and second electrodes during an address period, the two discharge spaces can be addressed during a first half and a second half of a single address period or during two distinct address periods. Sustain discharge for a single subfield can be generated in the two discharge spaces during a single sustain discharge period or during two distinct sustain discharge periods.

### CROSS REFERENCE TO RELATED APPLICATION

This application claims priority to and the benefit of Korea Patent Application No. 10-2004-0102240, filed on Dec. 7, 2004, which is hereby incorporated by reference for all purposes as if fully set forth herein.

### BACKGROUND OF THE INVENTION

1. Field of the Invention

The present invention relates to a plasma display panel (PDP), and, specifically, to a PDP having an improved structure and a method for driving thereof.

2. Discussion of the Background

Generally, a PDP is a display device which excites phosphors with vacuum ultraviolet (VUV) rays radiated from plasma obtained through gas discharge, and displays desired images by visible light generated by the excited phosphors.

A PDP having a three-electrode surface-discharge scheme is an example of a general PDP. In a PDP with a three-electrode surface discharge scheme, display electrodes are arranged on a front substrate in pairs, and address electrodes are arranged on a rear substrate, which is separated from the front substrate by a predetermined gap. In addition, a space between the front and rear substrates is partitioned by barrier ribs to form a plurality of discharge cells. A phosphor layer is arranged in the discharge cells on a portion of the rear substrate and the discharge cells contain a discharge gas.

Whether discharge is generated in a discharge cell depends upon an address discharge between one of the display electrodes and an address electrode arranged opposite to the display electrode. A sustain discharge displaying brightness is generated by the display electrodes located on the same surface. In a conventional PDP, the address discharge is generated as an opposed discharge and the sustain discharge is generated as a surface discharge.

Although a distance between the display electrode and the address electrode is greater than the distance between the pair of display electrodes, the discharge firing voltage of the address discharge is a lower voltage than the discharge firing voltage of the sustain discharge. Since the address discharge is induced by an opposed discharge, it has a discharge firing voltage lower than the voltage of the sustain discharge induced by a surface discharge. Therefore, a PDP in which a sustain discharge can be induced by an opposed discharge can have higher efficiency than the conventional PDP.

Discharge space in a PDP is divided into a sheath region and a positive column region. The sheath region refers to a non-light emitting region formed around where an electrode or dielectric layer is formed, in which most voltage is consumed. The positive column region refers to a region where a plasma discharge can be actively generated with a very low voltage. Therefore, to enhance efficiency of a PDP, the positive column region can be expanded. The length of the sheath region is not related to the discharge gap. Thus, expanding the positive column region can be achieved by increasing the discharge length. However, increasing the discharge gap to increase the discharge length may result in a high discharge firing voltage.

Thus, in a conventional PDP, low discharge firing voltage and high efficiency could not be realized at the same time.

Further, resolution is significantly related to display quality of a PDP. Therefore, there is an increasing need for a PDP in which resolution can be improved with the same area of discharge cells.

The above information disclosed in this Background section is only for enhancement of understanding of the background of the invention and therefore it may contain information that does not form the prior art that is already known in this country to a person of ordinary skill in the art.

### SUMMARY OF THE INVENTION

This invention provides a PDP with an improved structure.

This invention also provides a method for driving a PDP with an improved structure.

Additional features of the invention will be set forth in the description which follows, and in part will be apparent from the description, or may be learned by practice of the invention.

The present invention discloses a PDP including a first substrate, a second substrate disposed opposite to the first substrate and forming a space between the first substrate and second substrate, where the space is partitioned into a plurality of discharge cells, an address electrode arranged along a first direction, a first electrode electrically insulated from the address electrode and arranged at a first side of a discharge cell, along a second direction crossing the first direction, a second electrode electrically insulated from the address electrode and arranged at a second side of a discharge cell along a second direction crossing the first direction, where the second side is opposite to said first side, and a scan electrode arranged along the second direction between the first electrode and second electrode, and partitioning a discharge cell into a first discharge space and a second discharge space. Further, the first electrode is coupled with a first sustain line to form a first sustain electrode group, and the second electrode is coupled with a second sustain line to form a second sustain electrode group.

The present invention also discloses a method of driving a PDP, including in a first address period, addressing a first discharge space in a discharge cell by biasing a first sustain electrode with a first voltage, biasing a second sustain electrode with a second voltage lower than the first voltage, and applying a third voltage, which is lower than the first voltage, to a scan electrode, and in a second address period, addressing a second discharge space in the discharge cell by biasing the first sustain electrode with the second voltage, biasing the second electrode with first voltage, and applying the third voltage to the scan electrode. The first discharge space is formed between the first sustain electrode and the scan electrode and the second discharge space is formed between the second sustain electrode and the scan electrode.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 shows an exploded perspective view of a PDP according to a first embodiment of the present invention.

FIG. 2 shows a partial sectional view of the PDP according to the first embodiment, taken along line II-II in FIG. 1.

FIG. 3 shows a partial perspective view showing electrodes of the PDP according to the first embodiment of the present invention.

FIG. 4 shows a partial top plan view of the PDP according to the first embodiment of the present invention.

FIG. 5 shows a driving waveform for illustrating a driving method of a PDP according to a second embodiment of the present invention.

FIG. 6 shows a conceptual view of the driving method of the PDP according to the second embodiment of the present invention.

FIG. 7 shows a driving waveform for illustrating a driving method of a PDP according to a third embodiment of the present invention.

FIG. 8 shows a conceptual view of the driving method of the PDP according to a third embodiment of the present invention.

### DETAILED DESCRIPTION OF THE EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like numerals throughout the accompanying drawings refer to like components.

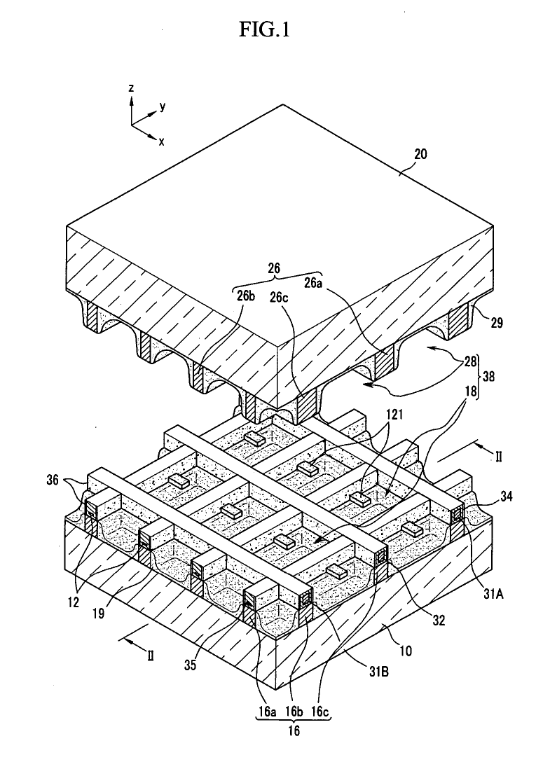

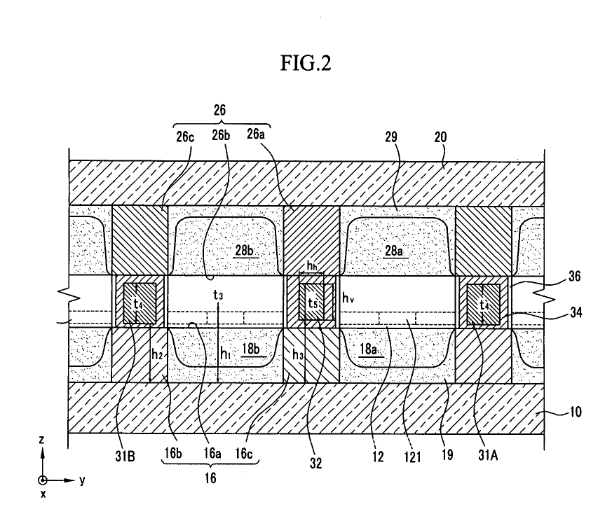

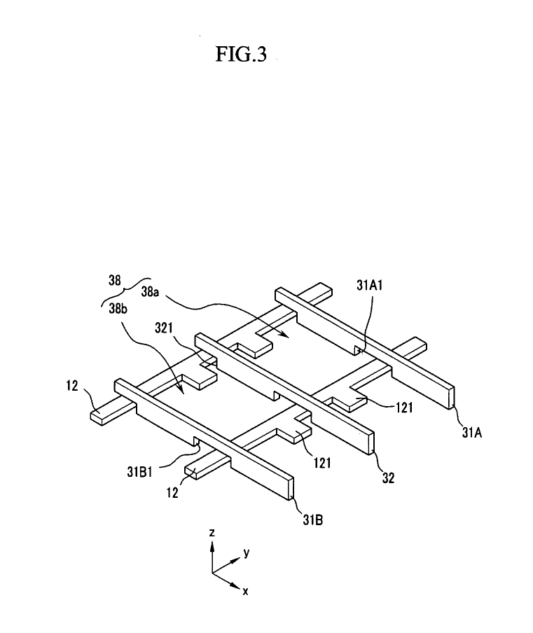

FIG. 1 shows an exploded perspective view of a PDP according to a first embodiment of the present invention, and FIG. 2 shows a partial sectional view of the PDP according to the first embodiment, which is taken along line II-II in FIG. 1. FIG. 3 shows a partial perspective view showing electrodes of the PDP according to the first embodiment of the present invention.

Referring to FIG. 1, the PDP according to the present embodiment includes a first substrate 10 (hereinafter referred to as a “rear substrate”) and a second substrate 20 (hereinafter referred to as a “front substrate”), which are disposed opposite to each other and separated by a predetermined distance therebetween. A first barrier rib 16 (hereinafter referred to as a “rear-plate barrier rib”) and a second barrier rib 26 (hereinafter referred to as a “front-plate barrier rib”) are disposed between the rear substrate 10 and the front substrate 20, and partition a plurality of discharge cells 38. A first phosphor layer 19 is arranged on a portion of the rear substrate that corresponds to discharge cells 38, and a second phosphor layer 29 is arranged on a portion of the front substrate that corresponds to discharge cells 38. First phosphor layer 19 and second phosphor layer 29 can include red, green, and blue phosphors for absorbing VUV rays and emitting visible light. In addition, the discharge cells 38 are filled with a discharge gas, including for example a mixed gas such as xenon (Xe) or neon (Ne), so that VUV rays can be generated with plasma discharge.

The rear-plate barrier rib 16 is formed adjacent to the rear substrate 10 and extends toward the front substrate 20. The front-plate barrier rib 26 is formed adjacent to the front substrate 20, extends toward the rear substrate 10, and corresponds to the rear-plate barrier rib 16 to partition the plurality of discharge cells 38. The rear-plate barrier rib 16 and the front-plate barrier rib 26 can partition the discharge cells 38 in a variety of shapes, such as rectangular, square, or hexagonal. The present embodiment illustrates the discharge cells 38 formed in a square shape.

The rear-plate barrier rib 16 includes a first barrier rib member 16a arranged along a first direction (a y-axis direction in the drawings), a second barrier rib member 16b arranged along a second direction (a x-axis direction in the drawings), and a third barrier rib member 16c arranged in the second direction and positioned parallel to and between two second barrier rib members 16b. The first barrier rib members 16a and the second barrier rib members 16b are arranged to cross each other to partition rear discharge cells 18 on a portion of the rear substrate 10.

In addition, the front-plate barrier rib 26 includes a fourth barrier rib member 26a arranged in a shape corresponding to the third barrier rib member 16c, a fifth barrier rib member 26b arranged in a shape corresponding to the first barrier rib member 16a, and a sixth barrier rib member 26c arranged in a shape corresponding to the second barrier rib member 16b.

Therefore, the fifth barrier rib members 26b and the sixth barrier rib members 26c are arranged to cross each other to partition front discharge cells 28 on a portion of the front substrate 20. Further, each front discharge cell 28 may correspond to one rear discharge cell 18.

A rear discharge cell 18 and a front discharge cell 28 corresponding to the rear discharge cell 18 substantially form one discharge cell 38.

As shown in FIG. 2, a third barrier rib member 16c partitions a rear discharge cell 18 into two discharge spaces 18a and 18b. A fourth barrier rib member 26a partitions a front discharge cell 28 into two discharge spaces 28a and 28b. A discharge cell 38 is substantially partitioned into two discharge spaces 38a and 38b, as shown in FIG. 3.

Furthermore, a first phosphor layer 19 is arranged in the rear discharge cells 18. The first phosphor layer 19 is formed on lateral sides of the barrier rib members 16a, 16b, and 16c forming the rear-plate barrier rib 16, and a bottom surface adjacent to the rear substrate 10 between the rear-plate barrier rib 16. A second phosphor layer 29 is arranged in the front discharge cells 28. The second phosphor layer 29 is formed on lateral sides of the barrier rib members 26a, 26b, and 26c forming the front-plate barrier rib 26, and a top surface adjacent to the front substrate 20 between the front-plate barrier rib 26.

Thus, the first phosphor layer 19 arranged within a rear discharge cell 18 and the second phosphor layer 29 arranged within a front discharge cell 28 that corresponds to the read discharge cell 18 can be formed using phosphors that emit visible light of the same color through collision of VUV rays generated by gas discharge.

In the present embodiment, since the front phosphor layer 19 and second phosphor layer 29 capable of generating visible light are formed on both sides of a discharge cell 38, brightness of the generated visible light may be improved.

Meanwhile, the first phosphor layer 19 arranged in a rear discharge cell 18 can be formed by forming a dielectric layer (not shown) on the rear substrate 10, forming the rear-plate barrier rib 16 thereon, and then coating phosphors on the dielectric layer (not shown). Alternately, the first phosphor layer 19 can be formed by forming the rear-plate barrier rib 16 on the rear substrate 10 and then coating phosphors thereon, without forming the dielectric layer on the rear substrate 10.

In the same manner, the second phosphor layer 29 arranged in a front discharge cell 28 can be formed by forming a dielectric layer (not shown) on the front substrate 20, forming the front-plate barrier rib 26 thereon, and then coating phosphors on a dielectric layer (not shown). Alternately, the second phosphor layer 29 can be formed by forming the front-plate barrier rib 26 on the front substrate 20 and then coating phosphors thereon, without forming the dielectric layer on the front substrate 20.

Furthermore, the first phosphor layer 19 can be formed by etching a substrate made of glass, for example, corresponding to the shape of two discharge spaces 18a and 18b of a rear discharge cell 18, and then coating phosphors thereon. In a similar manner, the second phosphor layer 29 can be formed by etching a substrate made of glass, for example, corresponding to the shape of two discharge spaces 28a and 28b of a front discharge cell 28 and then coating phosphors thereon. The rear-plate barrier rib 16 and the rear substrate 10 can be integrally formed of the same material. The front-plate barrier rib 26 and the front substrate 20 can be integrally formed of the same material.

After sustain discharge, the first phosphor layer 19 and the second phosphor layer 29 absorb VUV rays from the inside of the rear discharge cells 18 and the front discharge cells 28 and then generate visible light toward the front substrate 20. Visible light then passes through the second phosphor layer 29. Thus, to minimize loss of visible light, the thickness of the second phosphor layer 29 can be lower than the thickness of the first phosphor layer 19.

In addition, an address electrode 12, a first electrode 31A, a second electrode 31B, and a scan electrode 32 are provided corresponding to the discharge cells 38, respectively, between the rear substrate 10 and the front substrate 20 (between the rear-plate barrier rib 16 and the front-plate barrier rib 26, more exactly).

The scan electrode 32 selects a discharge cell 38 to be turned on, and generates an address discharge during an address period together with the address electrode 12. The first electrode 31A and second electrode 31B are sustain electrodes, and implement a predetermined brightness in a sustain discharge during a sustain period together with the scan electrode 32. However, first electrode 31A and second electrode 31B may play a different role depending on an applied signal voltage. Thus, the present invention is not restricted thereto.

In this embodiment, the same voltage is applied to the first electrodes 31A in the PDP to form a first sustain electrode group, and the same voltage is applied to the second electrodes 31B in the PDP to form a second sustain electrode group. The sustain electrode groups can be reduced by one electrode in a terminal region, so that the common same voltage is applied to the one electrode.

In the present embodiment, the first electrode 31A, the second electrode 31B, the scan electrode 32, and the address electrode 12 are arranged along the perimeter of a discharge cell 38. They can be formed of metal electrodes with good electrical conductivity.

The address electrode 12 is arranged in the first direction (the y-axis direction in the drawings), parallel to the first barrier rib member 16a, and corresponds to the first barrier rib member 16a between the rear-plate barrier rib 16 and the front-plate barrier rib 26. Specifically, the address electrode 12 may be positioned between the first barrier rib member 16a and the fifth barrier rib member 26b, and may be shared by a pair of discharge cells 38 adjacent to the address electrode 12 in the second direction (the x-axis direction in the drawings). Successive address electrodes 12 are spaced with a predetermined distance therebetween.

A first electrode 31A and a second electrode 31B extend in the second direction, while being electrically insulated from the address electrode 12, and are arranged corresponding to the second barrier rib members 16b. In the first embodiment, the first electrode 31A and the second electrode 31B are alternately disposed, and are arranged between the second barrier rib members 16b and the sixth barrier rib members 26c. Thus, they can divide adjacent discharge cells 38, and each first electrode 31A and second electrode 31B may be shared by adjacent discharge cells 38.

Furthermore, a scan electrode 32 is arranged between a first electrode 31A and a second electrode 31B and between the third barrier rib member 16c and the fourth barrier rib member 26a. Thus, each discharge cell 38 may be divided into a first discharge space 38a between a first electrode 31A and a scan electrode 32 and a second discharge space 38b between a second electrode 32A and the scan electrode 32. Therefore, a scan electrode 32 divides a discharge cell 38 into two discharge spaces 38a and 38b.

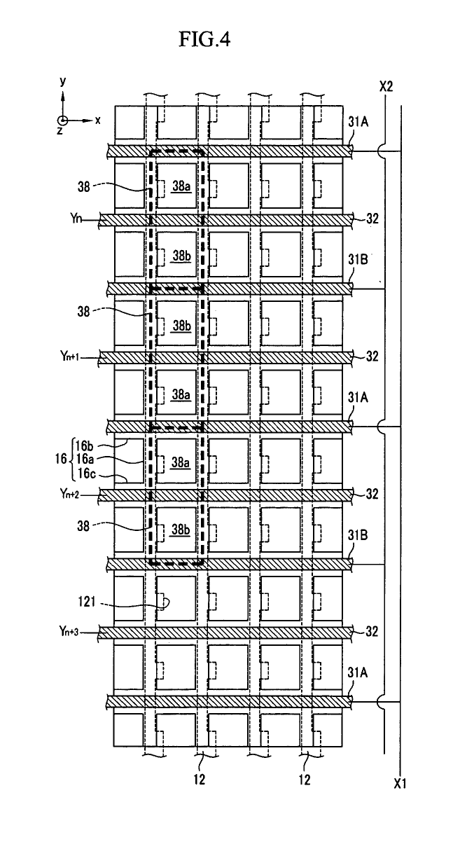

In the present embodiment, since the first electrode 31A and the second electrode 31B are shared by adjacent discharge cells 38 in the first direction, the first discharge spaces 38a of the adjacent discharge cells 38 are adjacent to each other and the second discharge spaces 38b of adjacent discharge cells 38 are adjacent to each other as shown in FIG. 4.

An address electrode 12 is shared by the two adjacent discharge cells 38 in the second direction. Thus, to select a discharge cell 38 to be turned on, a protruding portion 121 extending into a discharge cell 38 is arranged on the address electrode 12. The protruding portion 121 of the address electrode 12 applies a scan pulse, which is applied to the address electrode 12, to a discharge cell 38. Therefore, the protruding portion 121 causes the discharge cell 38 to be selected. Because protruding portion 121 shortens the discharge gap, the address discharge voltage is lowered.

In the present embodiment, an address discharge can be generated in each first discharge space 38a formed between the first electrode 31A and the scan electrode 32 and the second discharge space 38b formed between the second electrode 31B and the scan electrode 32 within one discharge cell 38. A protruding portion 121 of the address electrode 12 extends into a first discharge space 38a between the first electrode 31A and the scan electrode 32, and a protruding portion 121 of the address electrode 12 extends into a second discharge space 38b between the second electrode 31B and the scan electrode 32. Therefore, an address discharge can be generated in discharge spaces 38a and 38b arranged on two sides of scan electrode 32.

In the present embodiment, the first electrode 31A and the second electrode 31B participating in a sustain discharge and the scan electrode 32 are arranged opposite to each other and generate a sustain discharge as an opposed discharge. It is thus possible to lower a sustain discharge firing voltage.

As shown in FIG. 3, the first electrode 31A has an expansion portion 31A1, the second electrode 31B has an expansion portion 31B1, and the scan electrode 32 has an expansion portion 321. Expansion portions 31A1, 31B1, and 321 extend in a direction vertical to the rear substrate 10 (a Z-axis direction of the drawings) at a portion corresponding to each discharge cell 38 to generate a sustain discharge as an opposed discharge over a wider area. An opposed discharge includes discharge between electrodes positioned at opposite sides of a discharge space or discharge cell. The expansion portions 31A1, 31B1, and 321 have a sectional structure in which the height in a vertical direction (hᵥ) is greater than the width in a horizontal direction (hₕ) taken along a section vertical to the second direction (the x-axis direction of the drawings). An opposed discharge between the wider expansion portions 31A1, 31B1, and 321 generates strong VUV rays. The strong VUV rays increase the amount of visible light, which is generated through collision with the phosphor layers 19 and 29 across the wide area within the discharge cells 38.

Referring to FIG. 3, the first electrode 31A and the second electrode 31B and the scan electrode 32 have a uniform width along expansion portions 31A1, 31B1, and 321 and can cross the address electrodes 12 with protruding portion 121 while remaining electrically insulated. Although this embodiment illustrates the first and second electrodes 31A and 31B and the scan electrode 32 with uniform line width, the present invention is not restricted thereto.

Referring to FIG. 2, the distance (h₁) between the bottom of the protruding portion 121 of the address electrode 12 and the top portion of the rear substrate 10 is substantially the same as the distance (h₂) between the bottom of the first electrode 31A, the bottom of the second electrode 31B and the top portion of the rear substrate 10, and substantially the same as the distance (h₃) between the bottom portion of the scan electrode 32 and the top portion of the rear substrate 10. Thus, an opposed discharge can be generated between the scan electrode 32 and the protruding portion 121 of the address electrode 12. In addition, the thickness (t₃) of the address electrode 12 in a vertical direction (the z-axis direction of the drawings) is less than the thickness (t₄) of the first electrode 31A and the second electrode 31B and the thickness (t₅) of the scan electrode 32, thus preventing the address electrode 12 from obstructing a sustain discharge between the first electrode 31A and the scan electrode 32, and between the second electrode 31B and the scan electrode 32.

Dielectric layers 34 and 35 are formed with an insulation structure while surrounding the first electrode 31A, the second electrode 31B, the scan electrode 32, and the address electrode 12. The dielectric layers 34 and 35 can be fabricated by a Thick Film Ceramic Sheet (TFCS) method. The first electrode 31A, the second electrode 31B, the scan electrode 32, and the address electrode 12 can be fabricated by separately forming the dielectric layers 34 and 35, the respective electrodes formed therein, and then combining them with the rear substrate 10 on which the rear-plate barrier rib 16 is formed.

These dielectric layers 34 and 35 provide insulation between electrodes and also accumulate wall charges by discharge thereon. In the disclosed embodiment, the address electrode 12 is surrounded by the dielectric layer 35 having the same dielectric constant and can thus have the same discharge firing voltage in discharge cells, implementing red, green, and blue colors.

An MgO protective layer 36 can be formed on surfaces of the dielectric layers 34 surrounding the first electrode 31A, the second electrode 31B, and the scan electrode 32, and the dielectric layers 35 surrounding the address electrode 12. More particularly, the MgO protective layer 36 can be formed at a portion of the dielectric layers 34 and 35 exposed to plasma discharge occurring in the discharge space within the discharge cells 38. In the present embodiment, the first electrode 31A, the second electrode 31B, the scan electrode 32, and the address electrode 12 are located at portions which have substantially less contribution to display between the rear substrate 10 and the front substrate 20. Therefore, the MgO protective layer 36 coated on the dielectric layers 34 and 35 covering the first electrode 31A, the second electrode 31B, the scan electrode 32, and the address electrode 12 can be comprised of MgO with a visible light non-transparent characteristic. Non-transparent MgO has a secondary electron emission coefficient value that is significantly higher than that of transparent MgO. Accordingly, it can further lower a discharge firing voltage.

FIG. 4 shows a partial top plan view of the PDP according to the first embodiment of the present invention.

Referring to FIG. 4, each discharge cell 38 is divided into two discharge spaces 38a and 38b by means of the scan electrode 32, as described above. Scan electrodes 32 are coupled with scan lines Yn, Yn+1, Yn+2, Yn+3, etc. First electrodes 31A are coupled with sustain lines X1, and second electrodes 31B are coupled with sustain lines X2. In a sustain period, a sustain discharge is generated between a first electrode 31A and a scan electrode 32 in a first discharge space 38a, and a sustain discharge is generated between a second electrode 31B and a scan electrode 32 in a second discharge space 38b. Since a discharge is generated between a scan electrode 32 that passes through a discharge cell 38, and a first electrode 31A and a second electrode 31B arranged on opposite sides of a scan electrode 32, a discharge gap between electrodes participating in sustain discharge can be significantly reduced. Consequently, a discharge firing voltage can be further lowered.

Hereinafter, a method of driving the PDP in which each discharge cell 38 is divided into two discharge spaces 38a and 38b as described above will be described.

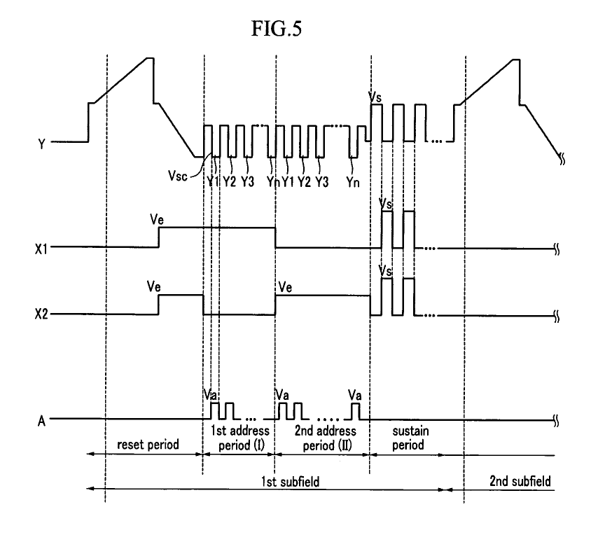

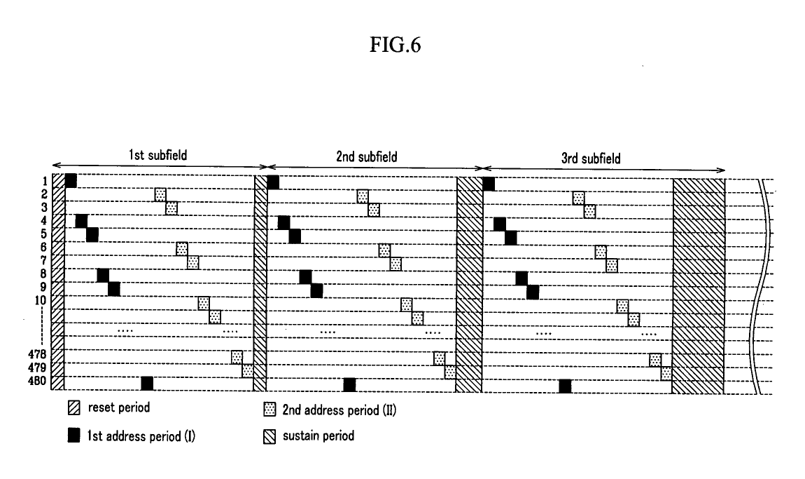

FIG. 5 shows a driving waveform for illustrating a driving method of a PDP according to a second embodiment of the present invention, and FIG. 6 shows a conceptual view showing the driving method of the PDP according to the second embodiment of the present invention. In this case, an odd line and an even line of FIG. 6 correspond to one discharge space, respectively. One odd line and one even line correspond to one discharge cell.

As shown in FIG. 5, each subfield of the driving method according to the present embodiment includes a reset period, an address period, and a sustain period. More particularly, the driving method according to the present embodiment includes a first address period (I), where one discharge space formed between a first electrode of a first sustain electrode group X1 and the scan electrode Y is selected, and a second address period (II), where the other discharge space formed between a second electrode of a second sustain electrode group X2 and the scan electrode Y is selected. Each discharge cell can be divided into two discharge spaces by a scan electrode Y.

First, in the reset period, a voltage that gradually rises then gradually falls can be applied to the scan electrodes Y. The reset period sets up wall charges to perform a next address discharge stably while erasing a wall charge state of a previous sustain discharge. While the ramp voltage that gradually falls is applied to the scan electrodes Y, the first sustain electrode group X1 and the second sustain electrode group X2 are biased with a voltage (Ve) to generate a weak discharge from the first sustain electrode group X1 and from the second sustain electrode group X2 to the scan electrodes Y.

Subsequently, in the address period, a discharge cell to be turned on is selected. In the present embodiment, the address period is divided into the first address period (I) and the second address period (II).

In the first address period (I), while the first sustain electrode group X1 is biased with voltage (Ve), a scan pulse voltage (Vsc) is sequentially applied to the scan electrodes Y1 . . . Yn. During the first address period (I), the second sustain electrode group X2 is not biased with voltage (Ve). Thus, a cell is selected by applying an address voltage (Va) to an address electrode A corresponding to a cell to be selected.

Referring to FIG. 6, numerals written on the left of the drawing designate discharge spaces within the plasma display panel. In the first address period (I), only discharge spaces where the first sustain electrode group X1 takes part in discharge (i.e., lines 1, 4, 5, 8, 9, etc. of FIG. 6). are addressed and thus selected. Since the voltage (Ve) is applied to only the first sustain electrode group X1, only discharge spaces where the first sustain electrode group X1 takes part in discharge generate an address discharge and are thus selected. This will be described below in more detail.

The voltage (Ve) applied to the first sustain electrode group X1 generates discharge between the first sustain electrode group X1 and the scan electrode Y at the initial stage of an address discharge, and attracts negative (−) wall charges generated in the address discharge toward the first sustain electrode group X1 after the address discharge. Therefore, where only the first sustain electrode group X1 is biased with the voltage (Ve) in the first address period (I), only a discharge space in which the first sustain electrode group X1 will take part in discharge is addressed. In the second address period (II), only the second sustain electrodes of group X2 are biased with the voltage (Ve). The scan pulse voltage (Vsc) is then sequentially applied to the scan electrodes Y1 . . . Yn while the first sustain electrode group X1 is not biased with voltage (Ve). Thus, a cell is selected by applying the address voltage (Va) to an address electrode 12 of a cell to be selected.

Referring to FIG. 6, in the second address period (II), only a discharge space where the second sustain electrode group X2 takes part in discharge is addressed or selected. Since the voltage (Ve) is applied to only the second sustain electrode group X2, discharge spaces (lines 2, 3, 6, 7, etc. of FIG. 6) where the second sustain electrode group X2 participates in a discharge generate an address discharge and are addressed accordingly.

Discharge spaces of each discharge cell, consisting of two discharge spaces, are all selected in the address period during the first address period (I) and the second address period (II).

Meanwhile, in the sustain period after the first address period (I) and the second address period (II), a sustain discharge pulse voltage (Vs) is alternately applied to the scan electrodes Y and the first sustain electrode groups X1 and second sustain electrode groups X2 to display images on discharge spaces that have been addressed in the address period. Although the same voltage (Vs or 0V) is simultaneously applied to the first sustain electrode group X1 and the second sustain electrode group X2 in the sustain period, a sustain discharge is generated only in discharge spaces that have been addressed in the address period.

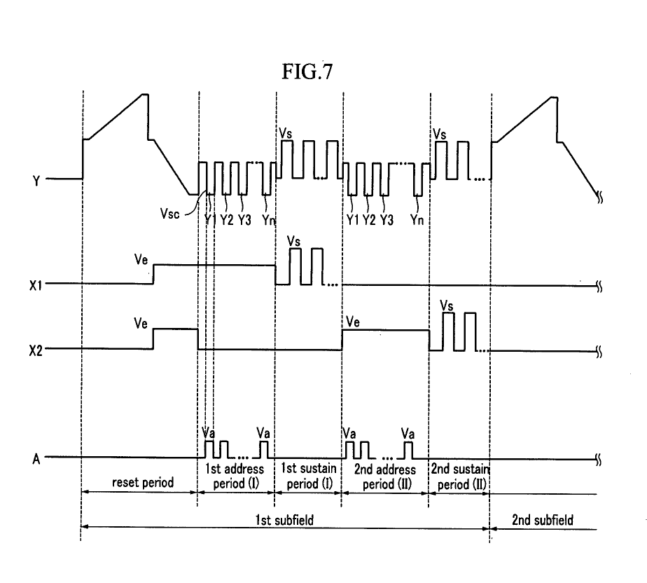

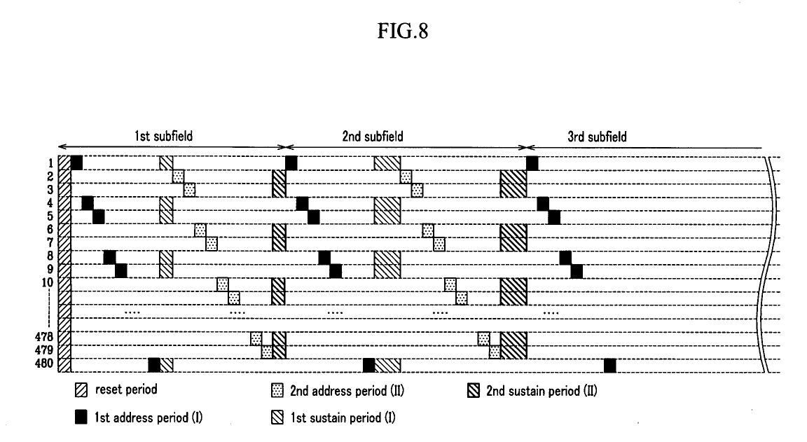

FIG. 7 shows a driving waveform for illustrating a driving method of a PDP according to a third embodiment of the present invention. FIG. 8 is a view conceptually showing the driving method of the PDP according to the third embodiment of the present invention. In FIG. 8, numerals written on the left of the drawing have the same meaning as in FIG. 6.

Referring to FIG. 7, the driving waveform according to the third embodiment of the present invention has a first sustain period (I) occurring after only discharge spaces where the first sustain electrode group X1 takes part in a discharge are selected in the first address period (I), and a second sustain period (II) occurring after only the discharge spaces 38b where the second sustain electrode group X2 takes part in a discharge are selected in the second address period (II). In the first address period (I), only the first sustain electrode group X1 is biased with the voltage (Ve), and the scan pulse voltage (Vsc) is sequentially applied to the scan electrodes (i.e., Y1, Y2, . . . Yn) in the same manner as in the second embodiment. Accordingly, only discharge spaces (lines 1, 4, 5, 8, 9, etc. of FIG. 8) where the first sustain electrode group X1 takes part in a discharge are addressed. After, in the first sustain period (I), the sustain discharge pulse voltage (Vs) is alternately applied to the scan electrodes Y and the first sustain electrode group X1, so that sustain discharge is generated only in discharge spaces where the first sustain electrode group X1 takes part in a discharge.

Thereafter, in the second address period (II), only the second sustain electrode group X2 is biased with the voltage (Ve), and the scan pulse voltage (Vsc) is sequentially applied to the scan electrodes Y (i.e., Y1, Y2, . . . Yn). Therefore, only discharge spaces (lines 2, 3, 6, 7, etc. of FIG. 8) where the second sustain electrode group X2 takes part in a discharge are addressed. Subsequently, in the second sustain period (II), the sustain discharge pulse voltage (Vs) is alternately applied to the scan electrodes Y and the second sustain electrode group X2, so that sustain discharge is generated only in discharge spaces where the second sustain electrode group X2 takes part in a discharge.

In this embodiment, the number of sustain pulses applied in the first sustain period (I) and the second sustain period (II) are the number allocated by a weight value of a subfield, and are the same for the two discharge spaces in a discharge cell. In addition, in FIG. 7 the sustain discharge pulse voltage (Vs) is not applied to the second sustain electrode group X2 in the first sustain period (I), and the sustain discharge pulse voltage (Vs) is not applied to the first sustain electrode group X1 in the second sustain period (II). However, the sustain discharge pulse voltage (Vs) can be applied to the second sustain electrode group X2 in the first sustain period (I) and the first sustain electrode group X1 in the second sustain period (II). This is because since only discharge spaces adjacent to the sustain electrode group X1 are selected in the first address period (I), a sustain discharge is not generated although the sustain discharge pulse voltage (Vs) is applied to the second sustain electrode group X2.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel (PDP), comprising:
a first substrate;
a second substrate disposed opposite to the first substrate and forming a space between the first substrate and the second substrate, said space is partitioned into a plurality of discharge cells;
an address electrode arranged along a first direction;
a first electrode electrically insulated from the address electrode and arranged at a first side of a discharge cell, along a second direction crossing the first direction;
a second electrode electrically insulated from the address electrode and arranged at a second side of a discharge cell along a second direction crossing the first direction, said second side opposite to said first side; and
a scan electrode arranged along the second direction between the first electrode and the second electrode, and partitioning a discharge cell into a first discharge space and a second discharge space,
wherein the first electrode is coupled with a first sustain line to form a first sustain electrode group, and the second electrode is coupled with a second sustain line to form a second sustain electrode group.

2. The PDP of claim 1, wherein the address electrode comprises a first protruding portion extending into a discharge space between the first electrode and the scan electrode and a second protruding portion extending into a discharge space between the second electrode and the scan electrode.

3. The PDP of claim 1, wherein the first electrode and the second electrode have a uniform electrode width.

4. The PDP of claim 1, further comprising:
a plurality of first electrodes;
a plurality of second electrodes,
wherein the first sustain electrode is shared by discharge cells adjacent in the first direction, the second sustain electrode is shared by discharge cells adjacent in the first direction, and the first sustain electrodes and the second sustain electrodes are alternately disposed.

5. The PDP of claim 1, further comprising:
a barrier rib disposed between the first substrate and the second substrate,
wherein the barrier rib comprises a plurality of first barrier rib members arranged along the first direction, a plurality of second barrier rib members arranged along the second direction, a plurality of third barrier rib members arranged along the second direction, each third barrier rib member arranged between two second barrier rib members and adjacent to the first substrate, and a plurality of fourth barrier rib members adjacent to the second substrate and arranged to correspond to the third barrier rib members.

6. The PDP of claim 5, wherein the scan electrode is positioned between a third barrier rib member and a fourth barrier rib member.

7. The PDP of claim 5, wherein the first barrier rib members and the second barrier rib members are adjacent to the first substrate and extend toward the second substrate.

8. The PDP of claim 7, wherein the barrier rib further comprises:
a plurality of fifth barrier rib members adjacent to the second substrate, arranged to correspond to the first barrier rib members, and extending toward the first substrate; and
a plurality of sixth barrier rib members adjacent to the second substrate, arranged to correspond to the second barrier rib members, and extending toward the first substrate.

9. The PDP of claim 8, wherein the first electrode and the second electrode are arranged between a second barrier rib member and a sixth barrier rib member.

10. The PDP of claim 1, wherein the first electrode and the second electrode comprise expansion portions, which extend from a portion of the first electrode and a portion of the second electrode corresponding to two sides of a discharge cell in a direction substantially orthogonal to the first substrate.

11. The PDP of claim 1, wherein the scan electrode comprises an expansion portion, which extends from a portion of the scan electrode corresponding to an internal portion of a discharge cell in a direction substantially orthogonal to the first substrate.

12. The PDP of claim 1, further comprising:
a first barrier rib formed adjacent to the first substrate; and
a second barrier rib formed adjacent to the second substrate,
wherein the address electrode, the first electrode, the second electrode, and the scan electrode are positioned between the first barrier rib and the second barrier rib.

13. The PDP of claim 12, further comprising:
a dielectric layer surrounding the address electrode, the first electrode, the second electrode, and the scan electrode,
wherein the dielectric layer is positioned between the first barrier rib and the second barrier rib.

14. A method of driving a PDP, the PDP having a first substrate and second substrate disposed opposite to each other and forming a space that is partitioned into discharge cells therebetween, address electrodes arranged along a first direction, first sustain electrodes and second sustain electrodes arranged at respective sides of each of the discharge cells along a second direction crossing the first direction, and scan electrodes arranged along the second direction between the first sustain electrodes and second sustain electrodes and partitioning the respective discharge cells into two discharge spaces, the method comprising:
(a) in a first address period, addressing a first discharge space in a discharge cell by biasing a first sustain electrode with a first voltage, biasing a second sustain electrode with a second voltage lower than the first voltage, and applying a third voltage, which is lower than the first voltage, to a scan electrode; and
(b) in a second address period, addressing a second discharge space in the discharge cell by biasing the first sustain electrode with the second voltage, biasing the second sustain electrode with the first voltage, and applying the third voltage to the scan electrode,
wherein the first discharge space is formed between the first sustain electrode and the scan electrode and the second discharge space is formed between the second sustain electrode and the scan electrode.

15. The method of claim 14, wherein an address electrode comprises a first protruding portion extending into the first discharge space and a second protruding portion extending into the second discharge space.

16. The method of claim 14, wherein the first sustain electrode is shared by discharge cells adjacent in the first direction, the second sustain electrode is shared by discharge cells adjacent in the first direction, and the first sustain electrodes and the second sustain electrodes are alternately disposed.

17. The method of claim 14, further comprising:
at step (a), while the third voltage is applied to the scan electrode, applying a fourth voltage, which is higher than the third voltage, to an address electrode to select the first discharge space; and
at step (b), while the third voltage is applied to the scan electrode, applying the fourth voltage to the address electrode to select the second discharge space.

18. The method of claim 17, further comprising:
(c) after step (b), alternately applying a fifth voltage and a sixth voltage to the scan electrode and the first and second sustain electrodes for generating a sustain discharge in the first discharge space and second discharge space.

19. The method of claim 17, further comprising:
alternately applying a fifth voltage and a sixth voltage to the scan electrode and the first sustain electrode for generating a sustain discharge in the first discharge space, between step (a) and step (b); and
alternately applying a fifth voltage and a sixth voltage to the scan electrode and the second sustain electrode for generating a sustain discharge in the second discharge space, after step (b).

20. The method of claim 14, further comprising:
applying a common voltage to a plurality of first electrodes in a first electrode sustain group; and
applying a common voltage to a plurality of second electrodes in a second electrode sustain group.
